(19) United States
(12) Patent Application Publication
(10) Pub. No.: US 2016/0193722 A1
(43) Pub. Date: Jul. 7, 2016

(54) DOUBLE BALL END FASTENER DRIVER

(71) Applicant: Eklind Tool Company, Franklin Park, IL (US)

(72) Inventor: Earl T. Cunningham, Glenview, IL (US)

(21) Appl. No.: 14/591,656

(22) Filed: Jan. 7, 2015

(51) Int. Cl. B25B 15/00; B25G 1/10; B25B 15/02

(52) U.S. Cl. CPC B25B 15/008; B25B 15/02; B25G 1/105

(57) ABSTRACT

A fastener driver comprising a substantially L-shaped shank having ball ends disposed at both opposite ends of a shank, the ball ends capable of angular insertion into a socket head of a fastener for the purpose of applying torque. The driver may also include an obtuse interior angle about the L-shaped shank, a stubby short arm, and a thick neck about the short arm and adjacent to the ball end thereof.

### FIELD OF THE INVENTION

This invention relates to tools that are used to drive fasteners having a socket head. More specifically, this invention relates to a fastener driver comprising a shank having rounded, ball ends disposed at both opposite ends of a shank, the ball ends capable of angular entry into a socket head of a fastener for the purpose of applying torque.

### BACKGROUND OF THE INVENTION

Fastener drivers include tools such as hexagonal wrenches, also known as hex keys, occurring in numerous sizes and having respective cross-sectional diameters that are traditionally uniform throughout. Hex keys are often L-shaped, comprising a long arm that is significantly longer than a short arm. Located at both opposite ends of the hex key is typically a hexagonal-shaped head designated for coaxial insertion into a complementary socket head fastener such that the fastener may be rotated by an application of force about an arm of the inserted tool.

The hex key may be rotated by the short arm about the central longitudinal axis of the long arm for quick run-in of a fastener. Alternatively, the hex key may be rotated in an opposite orientation about the short aim when applications of greater (i.e., “finishing”) torque upon the fastener are desired. A need for hex keys is often found, however, in narrow or cramped spaces that inherently do not accommodate a full range of uses for the tool in its aforementioned traditional state.

Some hex keys of the prior art include a long arm having a ball end intended to make insertion of the tool into a fastener socket more efficient and convenient Long arm ball end hex keys, for example, may broaden the range of angles by which the hex key may enter the fastener socket as compared to traditional linear engagements of the same. However, such hex keys may also exhibit a reduction in shear strength where the end of die tool has been honed into a ball. Thus, ball ends have been limited to the long arm of prior art hex keys, primarily because the greater torque loads typically exerted on the short arm may cause breakage of the ball end thereof and structural failure of the tool.

Many applications of hex key tools, however, not only demand the greater torque provided by rotation about the short arm, but they restrict use of the tool to this orientation due to the close proximity of the target fastener and surrounding work surfaces. In other words, some applications are exclusively satisfied by rotation of the hex key about the short arm, and many of those uses occur in quarters so tight that the hex keys of the prior art fail to accommodate both the tool and a user's hand in the workspace.

Accordingly, there is an unmet need for a general purpose fastener driver designed to provide the expediency of a ball end at both ends of the tool, sustain common torque loads about a short arm ball end without breaking, and, in particular, enable convenient manipulation of die driver by a user's hand within tight spaces where fasteners are to be engaged with finishing torque, as described herein.

### SUMMARY OF THE INVENTION

To meet the needs described above, the present disclosure provides a fastener driver having a ball end disposed at both opposite ends of a shank.

In a preferred embodiment, the driver is a unitary body that may be comprised of any material suitable for use in tools intended for the driving of fasteners, such as alloy steel. It is preferably provided in a substantially L-shaped configuration comprising a first ball end, a first neck, a first shank end, a shank, a second shank end, a second neck, a second ball end, and an interior angle α. The L-shaped configuration may be understood m this example to superficially divide the drives into a long arm and a short arm, both arms being integral with the driver. The long arm comprises the first ball end, the first neck, the first shank end, and a first portion of the shank. The short arm, on the other hand, composes the second ball end, the second neck, the second shank end, and a second portion of the shank.

In a preferred embodiment, the shank may have a polygonal cross-section and a substantially uniform diameter about its length. Preferably occurring along a region of the shank is angle α, which may be understood as the interior angle of the L. The region of the shank where angle α occurs may generally be regarded as the region of the driver where the long arm and the short arm meet and are thus provided at angle α relative to one another.

In a preferred embodiment, the necks are oriented outwardly from the respective shank ends. Both necks may occur as channels or notches in the driver, each having a diameter and a width. Each neck may have diameter that is constant along its width, and both the width and diameter of one neck may be dissimilar from the width and diameter of the other neck.

In a preferred embodiment the ball ends are oriented outwardly from the respective necks of the drives. The ball ends, although rounded, may include tapered polygonal facets whereby a cross-section of either ball end about its diameter reveals a polygonal shape. The respective shape, size, and cross-sectional profile of one ball end may be dissimilar from the other ball end.

In another preferred embodiment, the interior angle of the L is 100 degrees.

In another preferred embodiment, the diameter of the second neck is greater than the diameter of the first neck.

In yet another preferred embodiment, the length of the shore arm is no greater than four times the diameter of the shank, resulting in a “stubby” short arm of the driver.

Preferred embodiments of this invention provide a versatile and utilitarian driver used for driving fasteners having a socket bead. The ball end and neck features of the driver allow it to both enter the socket head at an angle relative the longitudinal axis of the fastener and also rotate the fastener along a similar angular relationship. This enhances the ease of use and utility of the tool in tight spaces as compared to traditional hex key tools lacking ball ends. Although it is contemplated that the driver may include a ball end at only the short arm end, preferred embodiments of this invention include a ball end at both ends of the driver. Therefore, the driver may be rotated about its long arm for quick run-in of a fastener, or the driver may be routed about its short arm during higher torque applications, both options being available to a user during practical implementations that incorporate the aforementioned angular relationship between the driver and the complementary fastener socket.

In addition to the second ball end feature of this invention, other preferred embodiments may include features that enhance the utility of the tool in certain applications. For example, wherein the diameter of the second neck is greater than the diameter of the first neck, the result is a second neck having a greater shear strength and capacity to withstand greater torque loads than the opposing first neck. This is because, although circumferential removal of material from the driver to form the neck enhances the range of entry angles at which the driver may enter a socket, the aforementioned removal may also weaken the driver at the neck location. Thus, providing a greater second neck diameter helps avoid breakage about the second neck and enables the driver to withstand the greater torque loads typically exerted upon that end.

Additionally, wherein preferred embodiments of the invention include an interior L angle of 100 degrees or a stubby short arm, the driver may enter a fastener socket at an enhanced variety of angles and in tighter workspaces where fasteners are otherwise impossible to access with traditional hex key tools lacking these features.

An objective of this invention is to solve a pervasive problem in the prior art whereby socket head fasteners occurring in cramped spaces may be driven by a single tool having one end that enables convenient fastener access at variable entry angles for application of enhanced torque loads, along with an opposite end that provides for quick fastener run-in applications as well.

An advantage of this invention is that it provides a tool having one ball end capable of sustaining enhanced torque loads and resisting breakage when rotating a socket bead fastener, while further providing an opposite ball end capable general purpose rotation of the same.

Another advantage of this invention is that may be manufactured from unitary stock materials, thus obviating additional expenses often associated with the manufacture of separate or customized parts to be later combined.

Yet another advantage of this invention is that it enhances access to socket head fasteners that are not only located in cramped workspaces but that also require significant torque load applications for adequate rotation.

### BRIEF DESCRIPTION OF THE DRAWINGS

FIG. 1 Is a side elevational view showing a preferred embodiment.

FIG. 1A is an enlarged partial view of a short arm of a preferred embodiment, as shown in the circle indicated in FIG. 1A.

FIG. 2 is a top elevational view shoving a preferred embodiment.

FIG. 3 is a perspective view showing a portion of a preferred embodiment at one end, captured along plane A-A as indicated in FIG. 2, and further showing a cross -sectional view of a shank of a preferred embodiment.

FIG. 4 is a side-by-side view of two examples of preferred embodiments provided in opposite orientations.

FIG. 4A is an enlarged side-by-side partial view of a first bail end and a first neck of a preferred embodiment, beside a second ball end and a second neck of a preferred embodiment, as shown in the circle indicated in FIG. 4.

FIG. 5 is a side elevational view of a preferred embodiment, as it is engaged wish a fastener at a first entry angle.

FIG. 5A is an enlarged partial view of a second ball end and a second neck of a preferred embodiment, as it is engaged with a fastener at a first entity angle, as shown in the circle indicated in FIG. 5.

FIG. 6 is an illustration showing ft preferred embodiment positioned among cramped work surfaces and showing an engagement of a second ball end and a second neck of the preferred embodiment with a fastener at a first entry angle.

FIG. 7 is a side elevational view of a preferred embodiment, as it is engaged with a fastener at a second entry angle.

FIG. 7A is an enlarged partial view of a second ball end and a second neck of a preferred embodiment, as it is engaged with a fastener at a second entry angle, as shown in the circle indicated in FIG. 7.

FIG. 8 is an illustration showing a preferred embodiment of this invention positioned among cramped work surfaces and showing an engagement of a second ball end and a second neck of the preferred embodiment engaged with a fastener at a second entry angle.

FIG. 9 is an illustration showing a preferred embodiment of this invention as a user's hand may comfortably fit among opposing work surfaces in a cramped workspace to engage, a second bail end and second neck of the preferred embodiment with a fastener.

### DETAILED DESCRIPTION OP THE EMBODIMENTS

While the invention may be susceptible to embodiment in different forms, there is shown in the drawings, and herein will be described in detail, specific preferred embodiments with the understanding that the present disclosure is to be considered an exemplification of the principles of the invention, and is not intended to limit the invention to that as illustrated and described herein.

Additionally, it will be understood that like or analogous elements and/or components, referred to herein, may be identified throughout the drawings by like reference characters. It will be likewise understood that the drawings are merely schematic representations of the invention, and some of the components may have been distorted from actual scale for purposes of pictorial clarity.

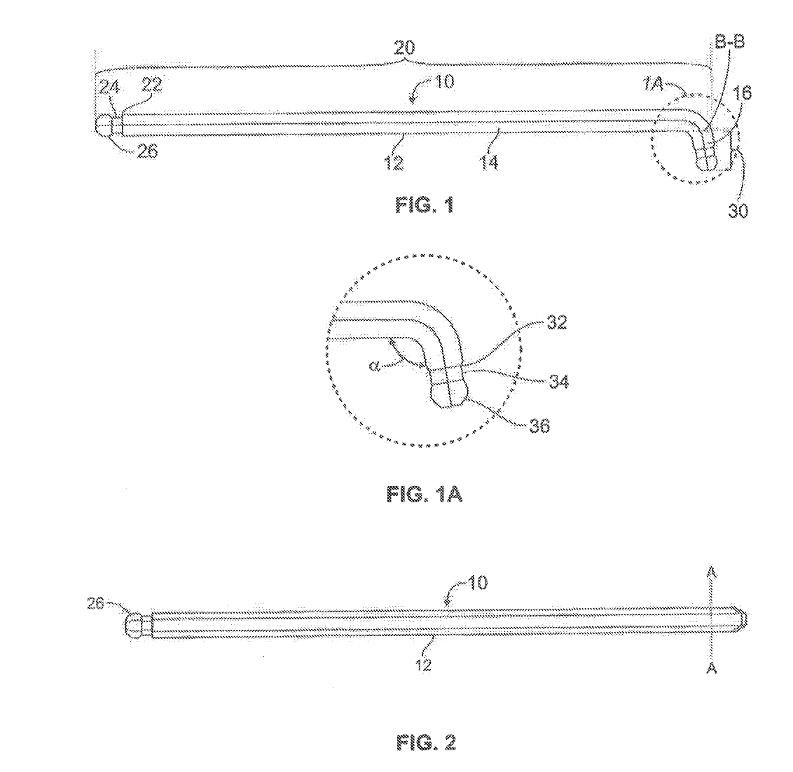

FIGS. 1 and 2 show an example of a double ball end fastener driver 10 provided in accordance with this invention. As shown in FIGS. 1 and 1A, the drives 10 is preferably provided in a substantially L-shaped configuration comprising a shank 12, a first shank end 22, a first neck 24, a first ball end 26, a second shank end 32, a second neck 34, a second ball end 36, and an interior angle α. The driver 10 is preferably a unitary body that may be formed from any structural material suitable for use in the driving of fasteners 50, such as carbon steel, stainless steel, or an aluminum alloy. Of course, numerous known material substitutes may be used, as will be appreciated by those of ordinary skill in the art.

The diameter of the driver 10 may be substantially uniform throughout, notwithstanding particular portions such as the necks 24, 34 and ball ends 26, 36 discussed in further detail below. The characteristics of a unitary body having a relatively uniform diameter allow the driver 10 to be manufactured from stock materials, thus obviating additional expenses often associated with the manufacture of separate or customized parts to be later combined. Accordingly, the designated portions of the driver 10 indicated herein generally define positions of milling and finishing about the driver 10 in this example, as opposed to attachment points or the like.

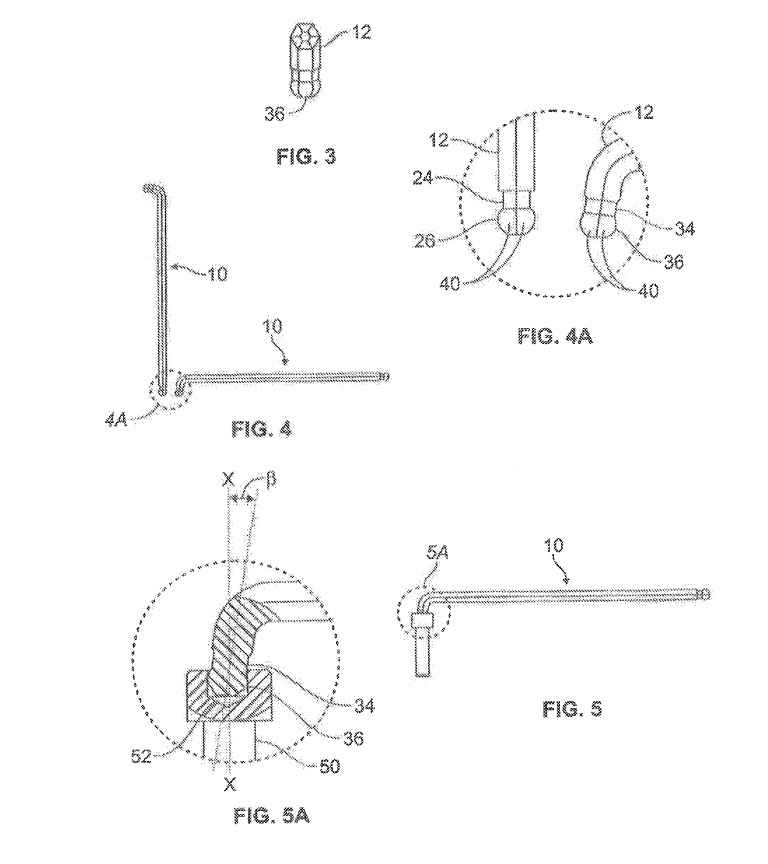

As shown in FIG. 1, the shank 12 may be an elongated structure that comprises a majority of the driver 10, the shank 12 extending from the first shank end 22 to the opposite second shank end 32. The shank 12 may have a polygonal cross-section, and as best shown in the preferred embodiment of FIG. 3, the cross-section of shank 12 at plane A-A (see FIG. 2) is hexagonal. However, it is understood that shank 12 may also have a circular, square, elliptical, star polygonal, asymmetrical, or irregular cross-sectional profile. The shank 12 is generally provided in a substantially L-shaped configuration whereby interior angle α may range from approximately 80 to 120 degrees. In a preferred embodiment she interior angle α may range from 90 to 110 degrees, and in a most preferred embodiment the interior angle α is 100 degrees, as shown in FIG. 1A.

The interior angle which may be understood as the interior angle or the L structure of the driver 10, generally divides the driver 10 into the superficial designations of a long arm 20 and a short arm 30 as shown in FIG. 1, the former preferably being substantially longer than the latter. Here, “superficial designation” means that the long arm 20 and the short arm 30 are terms used to indicate portions of the driver 10 defined by the L configuration, the arms 20, 30 being integral with the driver 10 and encompassing multiple respective structural features thereof. For example, die long arm 30 preferably includes the first ball end 26, the first neck 24, and a first portion 14 of the shank 12 which preferably extends from the first shank end 22 to bisection B-B, as shown in FIG. 1. Meanwhile, the short arm 30 preferably includes the second ball end 36, the second neck 34, and a second portion of the shank 12 which preferably extends from the second shank end 32 to bisection B-B. The first and second portions 14, 16 of the shank 12 preferably comprise the entirety of the shank 12. Thus, the long arm 20 is preferably provided at the interior angle α relative to the short arm 30.

As shown in FIG. 1, in a preferred embodiment, the short arm 30 has a length which is four times the diameter of the shank 12, A consequence of this ratio is a relatively “stubby” short arm 30. It is understood, however, that the short arm 30 may be provided at different lengths in other embodiments. In operation, preferred embodiments of the driver 10 may be rotated about a longitudinal axis of the long arm 20 by turning the short arm 30 where quick fastener 50 run-in applications are required. Alternatively, where applications of greater torque are required, the driver 10 may be rotated about an axis of the stubby short arm 30 by turning the long arm 20.

As further shown in the preferred embodiments of FIGS. 1 and 1A, extending outwardly from the first shank end 22 is the first neck 24, and extending outwardly from the second shank coo 32 is the second neck 34. Each neck 24, 34 has a defined width sad diameter, and the necks 34, 34 may be an indentation, or a channel circumnavigating the shank 12. Moreover, each neck 24, 34 may have a diameter that is constant along the width of the neck 24, 34.

The respective diameter of each neck 24, 34, which will generally be less than the diameter of the shank 12, is a substantial determinant for how each arm 20, 30 of driver 10 may engage a fastener socket 52 (see FIGS. 5A and 7A). For example, in a preferred embodiment, neck 34 of short arm 30 may have a diameter ranging from approximately 85 percent to approximately 95 percent of the shank 12 diameter. At such neck 34 diameters, an achievable entry angle among the second bail end 36 and the socket 52 ranges from approximately 5 degrees to approximately 15 degrees. The term “entry angle” as used herein may be understood to define a maximum angle by which driver 10 may enter a fastener 50 in relation to the longitudinal axis of the fastener socket 52, See, for example, FIGS. 5A and 7A. In a preferred embodiment, the diameter of neck 34 is approximately 90 percent of the shank 12 diameter and the entry angle is approximately 10 degrees. As for the long arm 20, the diameter of neck 24 may range from approximately 70 percent to approximately 95 percent of the shank 12 diameter. At such neck 24 diameters, an achievable entry angle among the first ball end 26 and the socket ranges from approximately 5 degrees to approximately 40 degrees. In a preferred embodiment, the diameter of neck 24 is approximately 75 percent of the shank 12 diameter and the entry angle is approximately 30 degrees.

As shown in FIGS. 4 and 4A, the diameter of the second neck 34 is greater than the diameter of the first neck 24. Thus, providing an optimal and greater diameter at the second neck 34 relative to the first neck 24 allows the driver 10 avoid breakage at neck 34 and withstand the greater torque loads typically exerted upon the second neck 30 end of the driver 10.

As further shown in FIGS. 1 and 4A, extending outwardly from the long arm neck 24 and the short arm neck 34 are the long arm ball end 26 and the short arm ball end 36, respectively, Both ball ends 26, 36 are generally comprised of rounded facets 40 that converge at the respective extreme ends of the driver 10. The number of rounded facets 40 about the ball ends 26, 36 may be equivalent to the facers of the shank 12, provided that the shank 12 has a polygonal cross-section. Alternatively, the ball ends 26, 36 may be comprised of a non-equivalent number of facets 40, or a number of facets 40 that differs from those exhibited by die shank 12, or other geometric configuration best suited to engage a target fastener 50. For example, ball ends 26, 36 may be honed from a square, hexagonal, or star polygonal profile. In a preferred embodiment, the ball ends 26, 36 are hone from a hexagonal cross-section. Each of the ball ends 26, 36 and the shank 12 may be dissimilar in cross-section.

As shown in FIGS. 5, 5A, 7, and 7A, the second ball end 36 is advantageous over the prior art because, inter alia, it allows the driver 10 to engage a fastener 50 at a wide range of entry angles, as opposed to engagement directly along the longitudinal axis X-X of the fastener 50 as required by hex keys having a straight (non-ball) end. Moreover, the adjacent second neck 34 enhances the achievable entry angles of the driver 10 about the fastener 50, whereby an entry angle of the driver 10 and fastener 50 engagement varies by approximately minus 10 degrees (angle β) to approximately plus 10 degrees (angle γ) off the longitudinal axis X-X of the fastener 50. Thus, the toll range of entry angles in this example is approximately 20 degrees.

A preferred embodiment of this invention may include a combination of the stubby short arm 30, the interior angle α of 100 degrees, the second neck 34, and the second ball end 36. The result is a novel and inventive driver 10 that lies flat when positioned on a substantially flat surface and enables convenient access and engagement of a fastener 50 by the second ball end 36 of the driver 10, even where the fastener 50 is located in a confined work space.

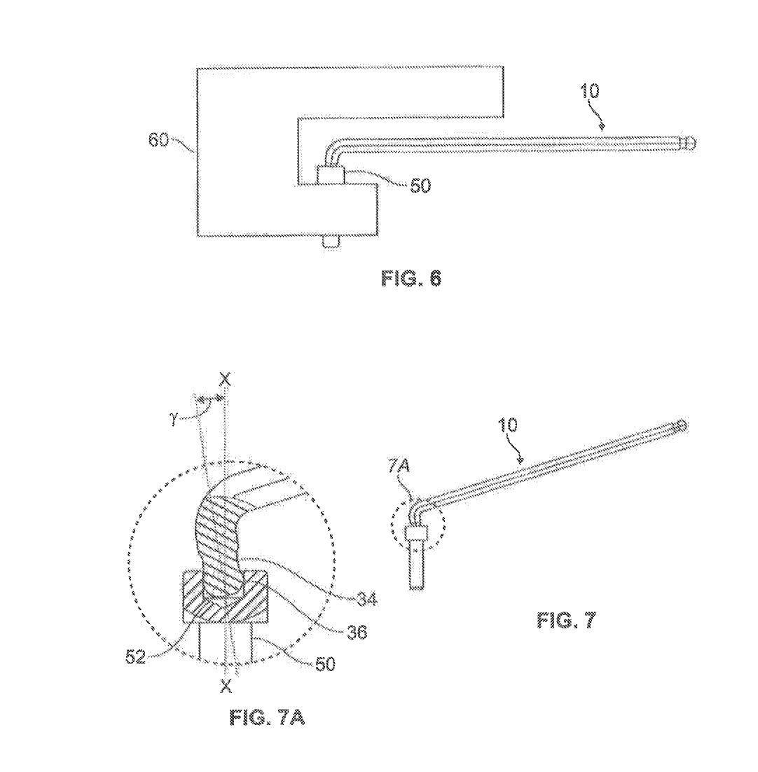

For examples shown in FIG. 6, an example of the driver 10 provided in accordance with this invention is engaged at approximately angle β (as shown its FIG. 5A) about fastener socket 52 of fastener 50. As shown in this example, fastener 50 is disposed in a cramped workspace among opposing work surfaces 60. Each of stubby short arm 30, angle α, and second ball end 36 and the convenience, by which driver 10 may access fastener SO in the cramped workspace. Together, these features amplify the range of entry angles (i.e., by tilting the driver 10) at which second ball end 36 may conveniently engage fastener socket 52 and consequently rotate fastener 50 in an advantageous way, particularly where fastener 50 is started at or rotated toward a closest proximity to an obstacle that would otherwise impede access to the fastener socket 32. Moreover, as shown in FIG. 6, fastener 50 is located in a space accessible only by the second ball end 36, as opposed to the first hail end 26. Accordingly, it is highly advantageous to engage such a fastener 50 with driver 10 where the dual benefit of versatility and strength are desired, as is commonly the case in fasteners 50 that require applications of finishing torque and are disposed in locations that are difficult to access.

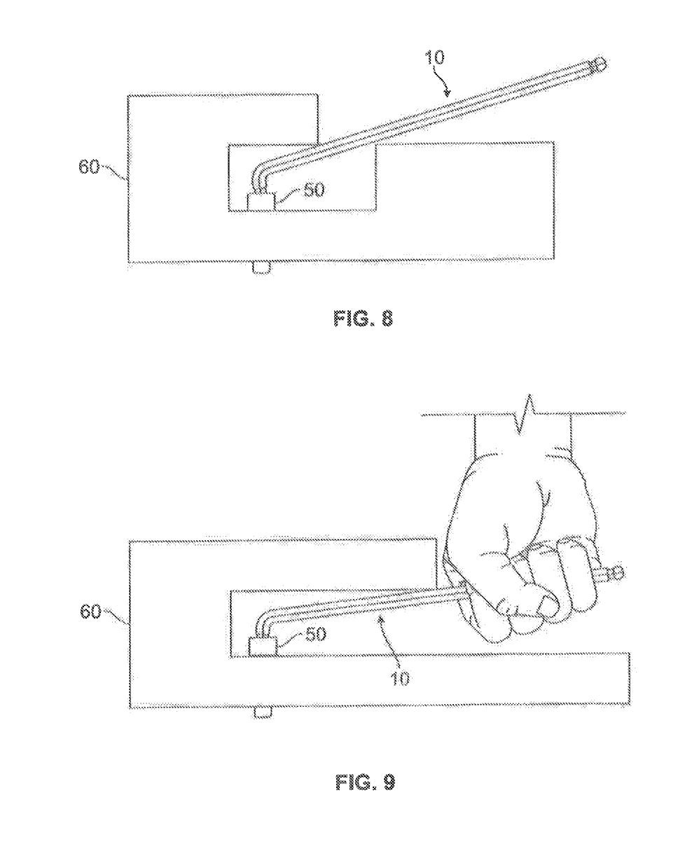

As shown in FIG. 8, an example of the driver 10 provided in accordance with this invention is engaged approximately at angle γ (as shown in FIG. 7A) about fastener socket 52 of fastener 50. FIG. 8, like FIG. 6, exhibits the versatility and utility of driver 10 used to engage fastener 50 provided in close proximity to surrounding work surfaces 60.

In yet another example shown in FIG. 9, a fastener 50 may be disposed along a surface separated from an opposing surface by a distance only marginally greater than the length of the stubby arm 30 of the driver 10. In such circumstances, the second ball end 36 of driver 10 provides the variable entry angles required to access the socket 52 and turn the fastener 50, particularly as the depth of the exposed body of the fastener 50 varies between the opposing surfaces as the fastener 50 is rotated. An additional advantageous consequence of die variable entry angles is the greater likelihood that a user of driver 10 will be able to wrap his/her hand around the long arm 20 and manipulate the driver 10 to engage and rotate the otherwise isolated fastener 50. Moreover, the second ball end 36 and the accompanying thicker second neck 34 will sustain greater torque loads and resist breakage. Thus, the driver 10 is a versatile, convenient, and high strength tool suitable for accessing and driving socket head fasteners 50 located in hard to reach spaces or otherwise.

While preferred embodiments of the present invention are shown and described, it is envisioned that those skilled in the art may devise various modifications of the present invention without departing from the spirit arid scope of the invention.

1. A driver comprising:
an elongated shank having first and second opposite shank ends;
first and second necks, the first neck extending outwardly from the first shank end of die elongated shank, the second neck extending outwardly from the second shank end of the elongated shank, the second neck having a diameter which is greater than a diameter of the first neck; and
first and second ball ends, the first ball end extending outwardly from the first neck, and the second ball end extending outwardly from the second neck.

2. The driver of claim 1, wherein the shank has a substantially uniform diameter.

3. The driver of claim 2, wherein the driver is a solitary body configured to lie substantially flat when positioned on a substantially flat surface.

4. The driver of claim 2, wherein the first ball end, the first neck, and a first portion of the elongated shank define a, long arts of the driver, and the second ball end, the second neck, and a second portion of the elongated shank define a short arm of the driver having a length that is less than a length of the long arm.

5. The driver of claim 4, wherein the length of the short arm is no greater than four times the diameter of the shank.

6. The driver of claim 4, wherein the short and long arms are provided at an angle relative to one another about a length of the shank.

7. The driver of claim 6, wherein the angle is between approximately 90 to 110 degrees.

8. The driver of claim 7, wherein the angle is 100 degrees.

9. The driver of claim 1, wherein the first ball end, the first neck, and a first portion of the elongated shank define a long arm of the driver, and the second ball end, the second neck, and a second portion of the elongated shank define a short arm of the driver having a length that is less than a length of the long arm.

10. The driver of claim 9, wherein the short and long arms are provided at an angle relative to one another about a length of the shank and the angle is between approximately 90 to 110 degrees.

11. The driver of claim 10, wherein the angle is 100 degrees.

12. The driver of claim 2, wherein the diameter of the second neck is constant along a width of the second neck.

13. The driver of claim 12, wherein the diameter of she second neck is between approximately 85 percent and approximately 95 percent of the diameter of the shank.

14. The driver of claim 13, wherein the diameter of the second neck is approximately 90 percent of the diameter of the shank.

15. The driver of claim 13, wherein the first ball end, the first neck, and a first portion of the elongated shank define a long arm of the driver, and the second ball end, the second neck, and a second portion of the elongated shank define a short arm of the driver having a length that is less than a length of the long arm.

16. The driver of claim 15, wherein the length of the short arm is no greater than four times the diameter of the shank.

17. The driver of claim 15, wherein the short and long arms are provided at an angle relative to one another about a length of the shank and the angle is between approximately 90 to 110 degrees.

18. The driver of claim 17, wherein the angle is approximately 100 degrees.
